(19) United States
(12) Patent Application Publication
(10) Pub. No.: US 2005/0211816 A1
(43) Pub. Date: Sep. 29, 2005

(54) Webbing take-up device

(75) Inventors: Hitoshi Takamatsu, Aichi-ken (JP); Tomonori Nagata, Aichi-ken (JP); Masaki Yasuda, Aichi-ken (JP); Toshimasa Yamamoto, Aichi-ken (JP); Kazuhiko Aihara, Aichi-ken (JP)

Correspondence Address: NIXON PEABODY, LLP, 401 9TH STREET, NW, SUITE 900, WASHINGTON, DC, 20004-2128, US

(73) Assignee: KABUSHIKI KAISHA TOKAI-RIKA-DENKI-SEISAKUSHO, Aichi-ken (JP)

(21) Appl. No.: 11/081,722

(22) Filed: Mar. 17, 2005

(30) Foreign Application Priority Data
Mar. 23, 2004 (JP) 2004-084035

(51) Int. Cl. B60R 22/46

(52) U.S. Cl. 242/374

(57) ABSTRACT

A moving member that causes a take-up shaft to rotate is prevented from passing through a limit position. In a webbing take-up device, a piston rises when a vehicle disposed with the webbing-take device experiences an emergency situation, whereby a pinion, a clutch plate, a lock gear, a torsion shaft and a spool are rotated, and a webbing is taken up. Thus, a flange of the piston abuts against a piston stopper fixed to a frame, and the rising energy of the piston is absorbed. Moreover, an upper end of the piston abuts against an inhibitor portion of a cover plate disposed at a limit position, and the rising of the piston is inhibited. Thus, the upper end of the piston causing the pinion to rotate can be reliably prevented from passing through the limit position.

### CROSS-REFERENCE TO RELATED APPLICATION

This application claims priority under 35 USC 119 from Japanese Patent Application No. 2004-4084035, the disclosure of which is incorporated by reference herein.

### BACKGROUND OF THE INVENTION

1. Field of the Invention

The present invention relates to a webbing take-up device disposed with a pretensioner mechanism that takes up a webbing by causing a moving member to move.

2. Description of the Related Art

There is a webbing take-up device disposed with a pretensioner mechanism that takes up a webbing by causing a piston to move and causing a pinion to rotate when a vehicle disposed with the webbing take-up device experiences an emergency situation (e.g., see Japanese Patent Application Laid-Open Publication (JP-A) No. 5-193445).

This webbing take-up device has a configuration where the piston and the pinion are covered by a cover plate.

However, in this webbing take-up device, the cover plate includes an opposing wall that opposes the piston in the moving direction of the piston, and the piston causing the pinion to rotate directly abuts against the opposing wall of the cover plate. Moreover, the opposing wall of the cover plate has a thickness that is substantially the same as that of the other portion of the cover plate. For this reason, it is desirable to prevent the piston causing the pinion to rotate from hitting and piercing the opposing wall of the cover plate and jumping outside the cover plate.

### SUMMARY OF THE INVENTION

In consideration of this circumstance, the present invention provides a webbing take-up device that is configured to prevent a moving member causing a take-up shaft to rotate from passing through a limit position.

A first aspect of the invention provides a webbing take-up device including: a take-up shaft around which a webbing is taken up as a result of the take-up shaft being rotated in a take-up direction; a pretensioner mechanism that includes a moving member and causes the moving member to move, to thereby cause the take-up shaft to rotate in the take-up direction; and an absorbing portion that is disposed at a position other than a limit position that limits passage of a moving end of the moving member, and which absorbs moving energy of the moving member as a result of the moving member causing the take-up shaft to rotate abutting against the absorbing portion.

In the webbing take-up device of the first aspect of the invention, the pretensioner mechanism causes the moving member to move, whereby the take-up shaft is rotated in the take-up direction and the webbing is taken up around the take-up shaft.

Here, the absorbing portion is formed at a position other than a limit position that limits the passage of the moving end of the moving member, and the moving member causing the take-up shaft to rotate abuts against the absorbing portion, whereby the moving energy of the moving member is absorbed. For this reason, the moving member causing the take-up shaft to rotate can be prevented from passing through the limit position.

A second aspect of the invention provides a webbing take-up device including: a take-up shaft around which a webbing is taken up as a result of the take-up shaft being rotated in a take-up direction; a pretensioner mechanism that includes a moving member and causes the moving member to move, to thereby cause the take-up shaft to rotate in the take-up direction; a first absorbing portion which is disposed at a position other than a limit position that limits passage of a moving end of the moving member, and which absorbs moving energy of the moving member as a result of the moving member that causes the take-up shaft to rotate abutting against the first absorbing portion; a frame that rotatably supports the take-up shaft; and a cover member that houses at least part of the pretensioner mechanism and is fixed to the outer side of one wall of the frame.

### BRIEF DESCRIPTION OF THE DRAWINGS

FIG. 1 is an exploded perspective view, seen diagonally from above one side, showing the relevant portions of a webbing take-up device according to an embodiment of the present invention;

FIG. 2 is an exploded perspective view, seen diagonally from above one side, showing in detail a characteristic portion of the webbing take-up device according to the embodiment of the present invention;

FIG. 3 is a rear view, seen from the other side, showing a cover plate of a first modified example of the webbing take-up device according to the embodiment of the present invention;

FIG. 4 is a rear view, seen from the other side, showing a cover plate of a second modified example of the webbing take-up device according to the embodiment of the present invention; and

FIG. 5 is a rear view, seen from the other side, showing a cover plate of a third modified example of the webbing take-up device according to the embodiment of the present invention.

### DETAILED DESCRIPTION OF THE INVENTION

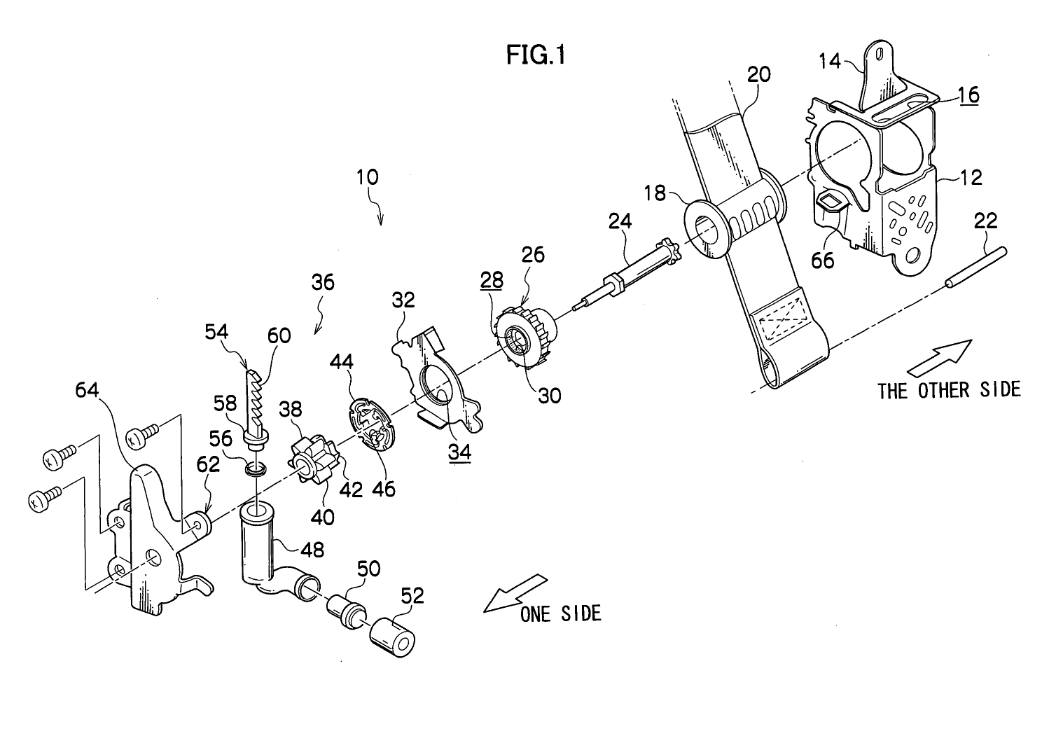

FIG. 1 is an exploded perspective view, seen diagonally from above one side, showing the relevant portions of a webbing take-up device 10 according to an embodiment of the present invention.

The webbing take-up device 10 according to the present embodiment is disposed with a frame 12 that has a substantial “U” shape when seen from above. The frame 12 is fixed inside a vehicle interior. A coupler piece 14 is disposed between an upper end of one side wall of the frame 12 and an upper end of the other side wall. The coupler piece 14 is fixed inside the vehicle interior, and a through hole 16 is formed in the coupler piece 14.

A spool 18 serving as a take-up shaft is rotatably supported between one side wall and the other side wall of the frame 12. A long belt-like webbing 20 is wound around the spool 18. A cylindrical shaft 22 disposed at a base end of the webbing 20 is locked to the spool 18. The vicinity of the base end of the webbing 20 is passed through the spool 18 and locked to the spool 18. The webbing 20 is also passed through the through hole 16 in the vicinity of the portion wound around the spool 18, and the webbing 20 is placed around a passenger of the vehicle disposed with the webbing take-up device 10. The webbing 20 is wound around the spool 18 as a result of the webbing 20 being wound in a take-up direction and is pulled out from the spool 18 as a result of the spool 18 being rotated in a pull-out direction.

A torsion shaft 24 (energy absorbing member) is disposed in a center axis portion of the spool 18. The other side end of the torsion shaft 24 is locked to the other side end of the spool 18, so that the torsion shaft 24 integrally rotates with the spool 18.

A lock gear 26 is disposed at one side of the spool 18. The lock gear 26 is locked to one side end vicinity of the torsion shaft 24, so that the lock gear 26 integrally rotates with the torsion shaft 24 and the spool 18. A substantially cylindrical knurled hole 28 is formed in the center of the lock gear 26. The knurled hole 28 opens to one side, and the entire outer periphery of the knurled hole 28 is knurled, so that a knurled surface 30 is formed.

A gear case 32 is fixed to the outer side of one side wall of the frame 12. The gear case 32 covers one side of the lock gear 26. A circular through hole 34 is formed in the center of the gear case 32. The through hole 34 exposes the knurled hole 28 of the lock gear 26.

A pretensioner mechanism 36 is disposed at the outer side of the gear case 32 at the outer side of one side wall of the frame 12. The pretensioner mechanism 36 includes a pinion 38 (rotating member). The pinion 38 is disposed at one side of the gear case 32 and is rotatably supported on the torsion shaft 24. Pinion teeth 40 are formed at one side portion of the pinion 38. A cam 42 is formed at the other side portion of the pinion 38. Convexo-concaves are formed around the outer periphery of the cam 42. The cam 42 is inserted inside the knurled hole 28 via the through hole 34 of the gear case 32 and does not contact the knurled surface 30, so that the lock gear 26 is rotatable independent of the pinion 36.

The pretensioner mechanism 36 includes a clutch plate 44 (clutch member). The clutch plate 44 is disposed between the gear case 32 and the pinion 38. Plural mesh pawls 46 are formed in the center of the clutch plate 44. The mesh pawls 46 protrude toward the other side from the clutch plate 44. The mesh pawls 46 fit into the concave portions of the cam 42, whereby the clutch plate 44 is attached to the pinion 38. The mesh pawls 46 are inserted together with the cam 42 inside the knurled hole 28 via the through hole 34 of the gear case 32 and do not contact the knurled surface 30, so that the lock gear 26 is rotatable independent of the clutch plate 44.

The pretensioner mechanism 36 includes a substantially “L” shaped cylinder 48. The cylinder 48 is fixed to the outer side of one side wall of the frame 12 below the pinion 38. A gas generator 50 is disposed at a lower side end of the cylinder 48, and a bottomed cylindrical generator cap 52 is fixed to the gas generator 50. The gas generator 50 blocks off the lower end side of the cylinder 48 in a state where the gas generator 50 is covered with the generator cap 52.

The pretensioner mechanism 36 includes a piston 54 serving as a moving member. The piston 54 is inserted inside the cylinder 48 from an upper end of the cylinder 48. An O ring 56 is disposed at a lower end of the piston 54. The O ring 56 seals the space between the lower end of the piston 54 and the cylinder 48. A discoid flange 58 serving as a projecting portion is formed in the vicinity of the lower end of the piston 54. The flange 58 protrudes from the piston 54 around the entire longitudinal direction (moving direction) of the piston 54. A rack 60 is formed on the piston 54 at a site other than the lower end and lower end vicinity of the piston 54. The surface of the rack 60 at the side opposite from the side facing the pinion 38 is planarly formed.

A generally triangular prism shaped, container-like cover plate 62 (cover member) is fixed to the outer side of one side wall of the frame 12. The other side surface and lower surface of the cover plate 62 are open. The cover plate 62 rotatably supports the torsion shaft 24 as a result of one side end of the torsion shaft 24 being passed through the cover plate 62 at the lower portion thereof, and houses the pinion 38, the clutch plate 44 and the upper portion of the piston 54. A peripheral wall of the cover plate 62 is formed in substantially the same thickness. An upper end wall (top wall) of the cover plate 62 configures an inhibitor portion 64 that is disposed at a limit position which limits the passage of the upper end (moving end) of the rising (moving) piston 54, as described later.

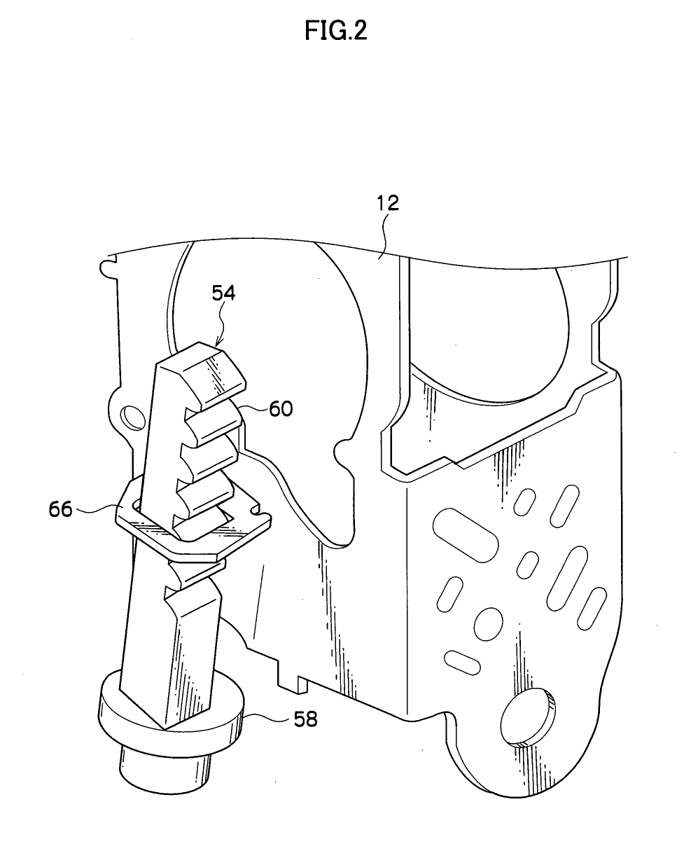

A generally square, ring-like piston stopper 66 serving as an absorbing portion is fixed to the outer side of one side wall of the frame 12. The piston stopper 66 is positioned between the upper end of the cylinder 48 and the lower end of the cover plate 62. As shown in FIG. 2, the piston 54 is passed through the inside of the piston stopper 66 so that the piston stopper 66 surrounds the piston 54 around the entire longitudinal direction. As described later, when the piston 54 rises, the entire periphery of the flange 58 of the piston 54 abuts against the entire periphery of the piston stopper 66 at the same time as, or immediately before, the upper end of the piston 54 reaches the inhibitor portion 64 of the cover plate 62.

Next, the action of the present embodiment will be described.

In the webbing take-up device 10 having the above configuration, when the vehicle experiences an emergency situation (e.g., at the time of a sudden deceleration) the pretensioner mechanism 36 is activated and the gas generator 50 generates gas, whereby the piston 54 rises through the cylinder 48 together with the O ring 56, the rack 60 of the piston 54 meshes with the pinion teeth 40 of the pinion 38, and the pinion 38 is rotated in the take-up direction. For this reason, the pinion 38 is rotated relatively with respect to the clutch plate 44, and the mesh pawls 46 of the clutch plate 44 mesh with the convex portions of the cam 42 of the pinion 38, whereby the mesh pawls 46 of the clutch plate 44 are moved outward in the radial direction of the clutch plate 44 and mesh with the knurled surface 30 of the lock gear 26. Thus, the clutch plate 44 and the lock gear 26 are rotated in the take-up direction integrally with the pinion 38, whereby the torsion shaft 24 and the spool 18 are rotated in the take-up direction integrally with the lock gear 26, and the webbing 20 is taken up.

Here, the piston stopper 66 is fixed to the outer side of one side wall of the frame 12 in a state where the piston stopper 66 is positioned between the upper end of the cylinder 48 and the lower end of the cover plate 62. As described above, the flange 58 of the piston 54 causing the pinion 38 to rotate abuts against the piston stopper 66, whereby the rising energy of the piston 54 is absorbed.

Moreover, the piston stopper 66 surrounds the piston 54 around the entire longitudinal direction, and the entire periphery of the flange 58 of the piston 54 abuts against the entire periphery of the piston stopper 66. Thus, the piston stopper 66 can effectively absorb the rising energy of the piston 54.

Moreover, the upper end of the piston 54 causing the pinion 38 to rotate abuts against the inhibitor portion 64 of the cover plate 62 disposed at the limit position that limits passage of the upper end of the piston 54, so that the rising of the piston 54 is inhibited.

Thus, the upper end of the piston 54 causing the pinion 38 to rotate can be reliably prevented from passing through the limit position (from going through the inhibitor portion 64).

Also, because the flange 58 protruding around the longitudinal direction of the piston 54 abuts against the piston stopper 66, the rising energy of the piston 54 can be absorbed with a simple configuration.

In the present embodiment, the webbing take-up device 10 has a configuration where the piston stopper 66 is separate from the cover plate 62, but the webbing take-up device 10 may also be configured so that the piston stopper 66 is integrated with the cover plate 62.

Also, in the present embodiment, the webbing take-up device 10 has a configuration where the piston stopper 66 served as the absorbing portion of the invention, but the webbing take-up device 10 may also be configured so that, together with this configuration, or instead of this configuration, the absorbing portion of the invention is disposed at the passage portion of the upper end of the piston 54 causing the pinion 38 to rotate.

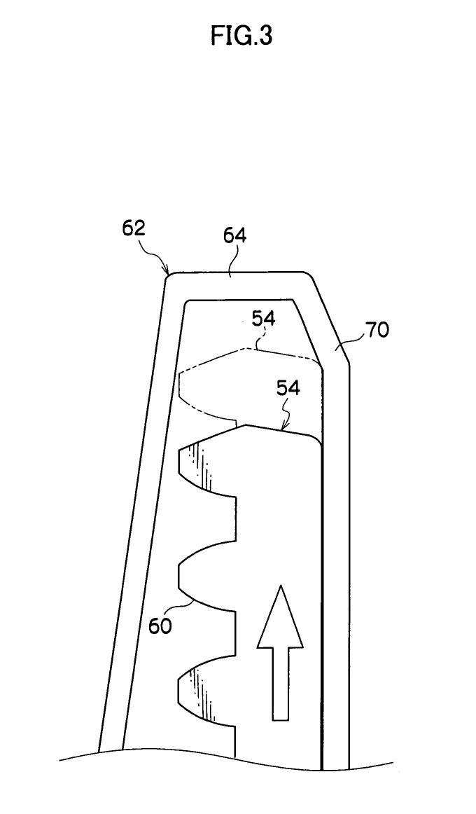

In this case, as in a first modified example shown in FIG. 3, at least one upper end of the side wall of the cover plate 62 may project towards the passage path side of the upper end of the piston 54 to serve as an absorbing portion 70, whereby the upper end of the piston 54 abuts against the absorbing portion 70 immediately before the upper end of the piston 54 reaches the inhibitor portion 64 (upper end wall) of the cover plate 62.

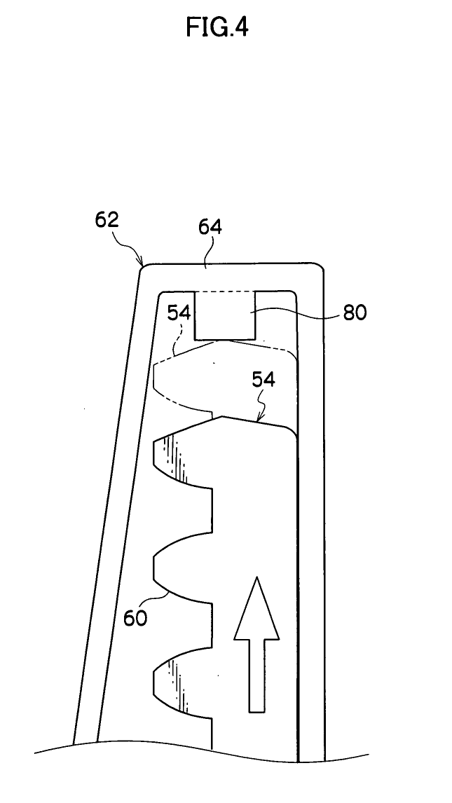

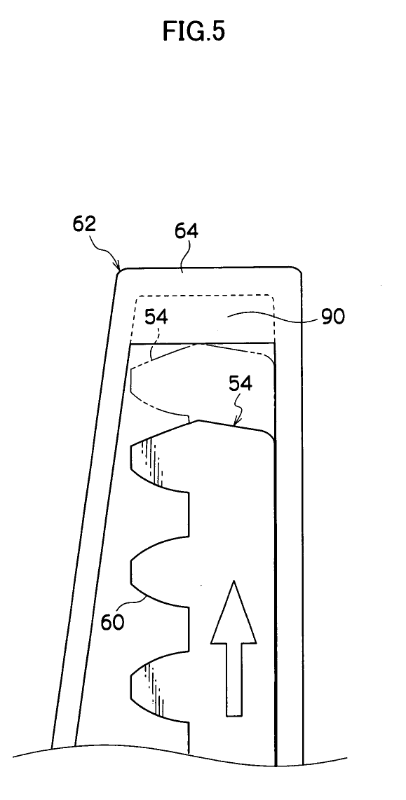

Moreover, an absorbing portion 80 may be formed on part of the undersurface of the inhibitor portion 64 of the cover plate 62, as in a second modified example shown in FIG. 4, or an absorbing portion 90 may be formed on the entire undersurface of the inhibitor portion 64 of the cover plate 62, as in a third modified example shown in FIG. 5. Thus, the upper end of the piston 54 abuts against the absorbing portion 80 or 90 immediately before reaching the inhibitor portion 64 of the cover plate 62.

Thus, even in the first to third modified examples, the rising energy of the piston 54 can be absorbed with a simple configuration.

In one aspect of the invention, the webbing take-up device is disposed with an inhibitor portion that is disposed at the limit position and inhibits the passage of the moving end of the moving member.

In this webbing take-up device, because the inhibitor portion disposed at the limit position inhibits the passage of the moving end of the moving member, the moving end of the moving member causing the take-up shaft to rotate can be more reliably prevented from passing through the limit position.

In another aspect of the invention, the webbing take-up device is disposed with a projecting portion that is disposed on the moving member, projects around a moving direction of the moving member and abuts against the absorbing portion.

In this webbing take-up device, the projecting portion disposed on the moving member projects around the moving direction of the moving member and abuts against the absorbing portion. For this reason, the moving energy of the moving member can be absorbed with a simple configuration.

In another aspect of the invention, the absorbing portion of the webbing take-up device surrounds the entire moving direction of the moving member.

In this webbing take-up device, because the absorbing portion surrounds the entire moving direction of the moving direction, the absorbing portion can effectively absorb the moving energy of the moving member.

In another aspect of the invention, the absorbing portion of the webbing take-up device is disposed at a passage position of the moving end of the moving member.

In this webbing take-up device, because the absorbing portion is disposed at the passage position of the moving end of the moving member, the moving energy of the moving member can be absorbed with a simple configuration.

1. A webbing take-up device comprising:
a take-up shaft around which a webbing is taken up as a result of the take-up shaft being rotated in a take-up direction;
a pretensioner mechanism that includes a moving member and causes the moving member to move, to thereby cause the take-up shaft to rotate in the take-up direction; and
an absorbing portion which is disposed at a position other than a limit position that limits passage of a moving end of the moving member, and which absorbs moving energy of the moving member as a result of the moving member that causes the take-up shaft to rotate abutting against the absorbing portion.

2. The webbing take-up device of claim 1, further comprising an inhibitor portion that is disposed at the limit position and inhibits the passage of the moving end of the moving member.

3. The webbing take-up device of claim 1, further comprising a projecting portion that is disposed on the moving member, projects around a moving direction of the moving member and can abut against the absorbing portion.

4. The webbing take-up device of claim 3, wherein the absorbing portion surrounds the moving member around the moving direction of the moving member.

5. The webbing take-up device of claim 1, wherein the absorbing portion is disposed at a passage position of the moving end of the moving member.

6. A webbing take-up device comprising:
a take-up shaft around which a webbing is taken up as a result of the take-up shaft being rotated in a take-up direction;
a pretensioner mechanism that includes a moving member and causes the moving member to move, to thereby cause the take-up shaft to rotate in the take-up direction;
a first absorbing portion which is disposed at a position other than a limit position that limits passage of a moving end of the moving member, and which absorbs moving energy of the moving member as a result of the moving member that causes the take-up shaft to rotate abutting against the first absorbing portion;
a frame that rotatably supports the take-up shaft; and
a cover member that houses at least part of the pretensioner mechanism and is fixed to the outer side of one wall of the frame.

7. The webbing take-up device of claim 6, wherein an upper end wall of the cover member configures an inhibitor portion that is disposed at the limit position and inhibits the passage of the moving end of the moving member.

8. The webbing take-up device of claim 6, wherein the first absorbing portion includes a hole portion and is fixed to the outer side of one wall of the frame, with the moving member being passed through the hole portion.

9. The webbing take-up device of claim 6, further comprising a projecting portion that is disposed on the moving member, projects from the moving member around a moving direction of the moving member and can abut against the first absorbing portion, wherein
the moving member moves and the projecting portion abuts against the first absorbing portion at the same time as, or immediately before, the moving end of the moving member reaches the inhibitor portion.

10. The webbing take-up device of claim 7, further comprising a second absorbing portion where at least part of upper end of a side wall of the cover member projects towards a passage path side of the moving end of the moving member, wherein
the moving member moves and the moving end of the moving member abuts against the second absorbing portion immediately before the moving end of the moving member reaches the inhibitor portion.

11. The webbing take-up device of claim 7, further comprising a third absorbing portion formed on part of a surface of the moving member side of the inhibitor portion, wherein
the moving member moves and the moving end of the moving member abuts against the third absorbing portion immediately before the moving end of the moving member reaches the inhibitor portion.

12. The webbing take-up device of claim 11, wherein the third absorbing portion is formed on the entire surface of the moving member side of the inhibitor portion.
